(19) United States
(12) Patent Application Publication
(10) Pub. No.: US 2023/0164300 A1
(43) Pub. Date: May 25, 2023

(54) SURVEILLANCE CAPSULE

(71) Applicant: DarkStar Vision Inc., Austin, TX (US)

(72) Inventors: Joseph Frank Scalisi, Lakeway, TX (US); Stefan Paul Medley, Austin, TX (US)

(21) Appl. No.: 18/058,211

(22) Filed: Nov. 22, 2022

Related U.S. Application Data
(60) Provisional application No. 63/282,573, filed on Nov. 23, 2021.

(51) Int. Cl. H04N 7/18; H04R 1/02; H04R 1/08; H04N 23/51; H04N 23/698; H04N 23/56

(52) U.S. Cl. CPC H04N 7/181; H04R 1/028; H04R 1/08; H04N 23/51; H04N 23/698; H04N 23/56

(57) ABSTRACT

The disclosure includes a surveillance capsule comprising a first protective shell, a second protective shell, a nose cap, and a camera. In some embodiments, the first protective shell is coupled to a first open end of the second protective shell, and the nose cap is coupled to a first open end of the first protective shell. The camera may be coupled to an opening of the nose cap. The surveillance capsule may include a weighted base located within the second protective shell configured to cause the surveillance capsule to be disposed in a free-standing, self-righting, upright position.

### CROSS-REFERENCE TO RELATED APPLICATIONS

The entire contents of the following application are incorporated by reference herein: U.S. Provisional Patent Application No. 63/282,573; filed Nov. 23, 2021; and entitled SURVEILLANCE CAPSULE.

### BACKGROUND

### Field

Various embodiments disclosed herein relate to surveillance systems. Certain embodiments relate to portable surveillance capsules for remote surveillance.

### Description of Related Art

Hazardous situations may be present where remote surveillance of a room or other environment is desired. For instance, finding the location of persons in need of rescue, such as victims of a situation where fire is present, or determining the location of perpetrators in a crime scene, may benefit significantly from remote surveillance. Such surveillance is often required on an ad hoc basis. It would be most desirably carried out using highly mobile tools that are robust to reliably hold up in adverse environments. A need exists for surveillance tools meeting these foregoing criteria.

### SUMMARY

The disclosure includes a surveillance capsule comprising a first protective shell defining a first open end, a second open end located opposite the first open end, and a hollow portion extending between the first open end and the second open end, and a second protective shell defining a first open end, a second closed end, and an internal portion located between the first open end of the second protective shell and the second closed end, the first open end coupled to the second open end of the first protective shell. The surveillance capsule may also include a nose cap defining a first end, a second end located opposite the first end, and an opening adjacent the first end, whereby the second end of the nose cap may be coupled to the first open end of the first protective shell. The surveillance capsule may further comprise a camera coupled to the opening of the nose cap.

In some embodiments, the surveillance capsule further comprises a weighted base located within the internal portion of the second protective shell, the weighted base configured to cause the surveillance capsule to be disposed in a free-standing, self-righting, upright position. The surveillance capsule may also include at least one microphone coupled to the first protective shell and at least one speaker coupled to the first protective shell. In some embodiments, the at least one microphone and the at least one speaker are configured to enable two-way communication between a first user located adjacent the surveillance capsule and a second user of a remote computing device communicatively coupled to the surveillance capsule.

The surveillance capsule may also include at least one sensor selected from the group consisting of a temperature sensor, a smoke detector, a motion sensor, a gyroscope sensor, a light sensor, and combinations thereof, wherein the at least one sensor may be coupled to the first protective shell. In some embodiments, the surveillance capsule further comprises a transmitter coupled to the first protective shell and communicatively coupled to the at least one sensor, the transmitter configured to transmit information detected by the at least one sensor to the remote computing device. The transmitter may be configured to transmit at least one image captured by the camera to the remote computing device.

In some embodiments, the surveillance capsule includes a rechargeable battery located within the internal portion of the second protective shell, the rechargeable battery electrically coupled to a component selected from the group consisting of the camera, the at least one microphone, the at least one speaker, the at least one sensor, and the transmitter. The surveillance capsule may also include a hollow cylinder located within the hollow portion of the first protective shell and a printed circuit board (PCB) located within the hollow cylinder. In some embodiments, the hollow cylinder is filled with resin to protect the PCB.

The camera may be configured to extend from the opening of the nose cap in a direction opposite the second protective shell. In some embodiments, the surveillance capsule comprises at least one infrared sensor coupled to a component selected from the group consisting of the nose cap, the first protective shell, the second protective shell, and combinations thereof, wherein the at least one infrared sensor is configured to enable night vision. The surveillance capsule may include a plurality of light-emitting diodes (LEDs) coupled to a component selected from the group consisting of the nose cap, the first protective shell, the second protective shell, and combinations thereof, wherein the plurality of LEDs may be configured to enable night vision.

In some embodiments, the first open end of the second protective shell is threadably coupled to the second open end of the first protective shell. The second end of the nose cap may be threadably coupled to the first open end of the first protective shell. In some embodiments, the first protective shell, the second protective shell, and the nose cap are comprised of a ballistic-grade plastic material.

The disclosure includes a method of providing surveillance using a surveillance capsule, the surveillance capsule including a first protective shell defining a first open end and a second open end located opposite the first open end, a second protective shell coupled to the second open end of the first protective shell, a nose cap coupled to the first open end of the first protective shell, a camera coupled to the nose cap, at least one sensor coupled to the first protective shell, and a transmitter coupled to the first protective shell and communicatively coupled to the camera and the at least one sensor. The method may include capturing, by the camera, at least one image, detecting, by the at least one sensor, information about an environment surrounding the surveillance capsule, and transmitting, via the transmitter, the at least one image and the information detected by the at least one sensor to a remote computing device communicatively coupled to the surveillance capsule.

In some embodiments, the surveillance capsule is a first surveillance capsule, and the method further comprises capturing, by a camera of a second surveillance capsule, at least one image. The method may also include detecting, by at least one sensor of the second surveillance capsule, information about an environment surrounding the second surveillance capsule, and transmitting, via a transmitter of the second surveillance capsule, the at least one image and the information detected by the at least one sensor to a remote computing device communicatively coupled to the second surveillance capsule.

In some embodiment, the method includes transmitting, via the transmitter of the first surveillance capsule, the at least one image and the information detected by the at least one sensor of the first surveillance capsule to the second surveillance capsule. The method may include transmitting, via the transmitter of the second surveillance capsule, the at least one image and the information detected by the at least one sensor of the second surveillance capsule to the first surveillance capsule.

### BRIEF DESCRIPTION OF THE DRAWINGS

Features, aspects, and advantages are described below with reference to the drawings, which are intended to illustrate, but not to limit, the disclosure herein. In the drawings, like reference characters denote corresponding features consistently throughout similar embodiments.

FIG. 1 illustrates a perspective view of a surveillance capsule, according to some embodiments.

FIGS. 2 and 3 illustrate exploded views of a surveillance capsule, according to some embodiments.

FIG. 4 illustrates a block diagram of a system including a surveillance capsule, according to some embodiments.

FIG. 5 illustrates a schematic of a system including a surveillance capsule, according to some embodiments.

FIGS. 6, 7, 8, and 9 illustrate block diagrams of systems including at least one surveillance capsule and at least one remote computing device, according to some embodiments.

### DETAILED DESCRIPTION

Although certain embodiments and examples are disclosed below, inventive subject matter extends beyond the specifically disclosed embodiments to other alternative embodiments and/or uses and modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order-dependent. Additionally, the structures, systems, and/or devices described herein may be embodied as integrated components or as separate components.

For purposes of comparing various embodiments, certain aspects and advantages of these embodiments are described. All such aspects or advantages are not necessarily achieved by any particular embodiment. For example, various embodiments may be carried out in a manner that achieves or optimizes one advantage or group of advantages as taught herein without necessarily achieving other aspects or advantages as may also be taught or suggested herein.

### Component Index

100—surveillance capsule
102—first protective shell
104—second protective shell
106—nose cap
108—camera
202a—first open end (first protective shell)
202b—second open end (first protective shell)
204a—first open end (second protective shell)
204b—second closed end (second protective shell)
206a—first end (nose cap)
206b—second end (nose cap)
208—hollow portion (first protective shell)
210—internal portion (second protective shell)
212—weighted base
214—opening (nose cap)
300—hollow cylinder
302—printed circuit board
304—seal
306—battery
400—remote computing device
402—at least one microphone
404—at least one speaker
406—at least one sensor
408—transmitter
410—at least one infrared sensor
412—plurality of LEDs
414—microcontroller
416—receiver
500—network
502—wearable smart device

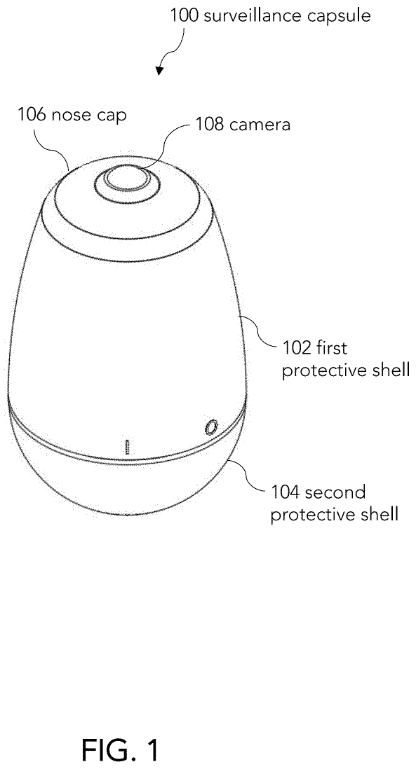

FIG. 1 illustrates a perspective view of a surveillance capsule 100. In some embodiments, the surveillance capsule 100 includes a first protective shell 102, a second protective shell 104, a nose cap 106, and a camera 108. As illustrated in FIG. 1, the surveillance capsule 100 may define a pyriform-shaped structure wherein the second protective shell 104 may define a hemispherically-shaped base. As will be discussed in greater detail later in the disclosure, the surveillance capsule 100 may be self-righting such that, in connection with it being thrown in a room, the surveillance capsule 100 may lie free standing on a surface upon which the hemispherically-shaped base rests.

The surveillance capsule 100 may be used in environments ranging from purposes connected with police and fire surveillance to rescue scenarios. The surveillance capsule 100 with its self-righting properties may be thrown or dropped into an environment, for example, by hand or via a launching mechanism (i.e., to reach an upper level of a building). The surveillance capsule 100, specifically the first protective shell 102, the second protective shell 104, the nose cap 106, and the camera 108, may be constructed of ballistic-grade plastic (or any other durable material including, but not limited to, aluminum and carbon fiber) to absorb shock and protect the internal components of the surveillance capsule 100 from damage that might otherwise result from having thrown or dropped the surveillance capsule 100 into the environment. Further, the surveillance capsule 100 may be fire and heat-resistant or may offer fire and heat resistance to internal components.

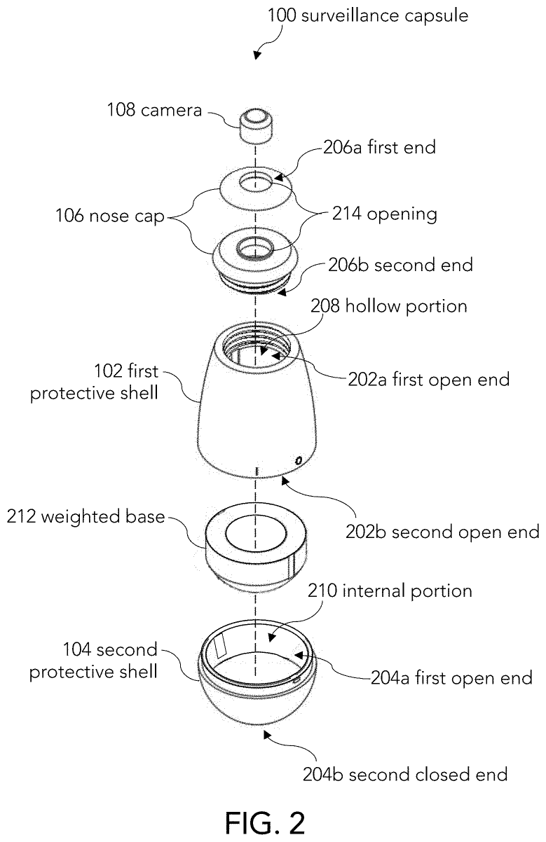

FIG. 2 illustrates an exploded view of the surveillance capsule 100, showing several components. As previously discussed, the surveillance capsule 100 may include a first protective shell 102, a second protective shell 104, a nose cap 106, and a camera 108. In some embodiments, the first protective shell 102 defines a first open end 202a, a second open end 202b located opposite the first open end 202a, and a hollow portion 208 extending between the first open end 202a and the second open end 202b. Similarly, the second protective shell 104 may define a first open end 204a and a second closed end 204b located opposite the first open end 204a, with an internal portion 210 located therebetween, as illustrated in FIG. 2.

FIG. 2 also includes a weighted base 212. In some embodiments, the weighted base 212 is located within the internal portion 210 of the second protective shell 104. Stated differently, the second protective shell 104 may be configured to hold the weighted base 212. In some embodiments, the weighted base 212 is what enables the “self-righting” properties of the surveillance capsule 100 discussed above. The higher weight of the weighted base 212 as compared to the nose cap 106 may be configured to cause the surveillance capsule 100 to be disposed in a free-standing, self-righting, upright position.

As shown in FIG. 2, the nose cap 106 may comprise two pieces. In some embodiments, the nose cap 106 comprises a single-piece construction. The nose cap 106 may comprise more than two pieces. In some embodiments, as illustrated, the nose cap 106 defines a first end 206a and a second end 206b located opposite the first end 206a. The nose cap 106 may also include an opening 214 adjacent the first end 206a, wherein the camera 108 may be coupled to the opening 214. In addition, the camera 108 may be configured to at least partially extend through the opening 214, as shown in FIG. 1. In some embodiments, the camera 108 extends through the opening 214 in a direction opposite the second protective shell 104. Stated another way, if the second protective shell 104 is considered the “base” or “bottom” of the surveillance capsule 100, then the camera 108 may be considered as extending out of the “top” of the surveillance capsule 100.

In some embodiments, the camera 108 is configured to capture at least one image in a field of view defining 360 degrees around the camera 108. As such, the camera 108 may be capable of capturing a panoramic perspective around the surveillance capsule 100. It should be noted that the camera 108 may be capable of capturing static image(s) as well as live video. Though not shown in the figures, the camera 108 may include a lens cover constructed of the same durable material as the first protective shell 102, the second protective shell 104, and the nose cap 106, wherein the lens cover may be configured to protect the camera 108.

As indicated by the dashed line in FIG. 2, the components may be configured to couple to one another in the order shown. For example, as previously discussed, the camera 108 may be configured to couple to the opening 214 adjacent the first end 206a of the nose cap 106. In some embodiments, the second end 206b of the nose cap 106 is configured to couple to the first open end 202a of the first protective shell 102. The second open end 202b of the first protective shell 102 may, in turn, be configured to couple to the first open end 204a of the second protective shell 104, with the weighted base 212 held within the second protective shell 104. The weighted base 212 may also extend partially into the first protective shell 102 when the surveillance capsule 100 is assembled. Each of the aforementioned elements may couple to one another using any suitable method of mechanical coupling including, but not limited to, threadable coupling, friction fit, channel locks, magnetic coupling, mechanisms such as nuts, bolts, etc., adhesive, and/or any number of other suitable methods.

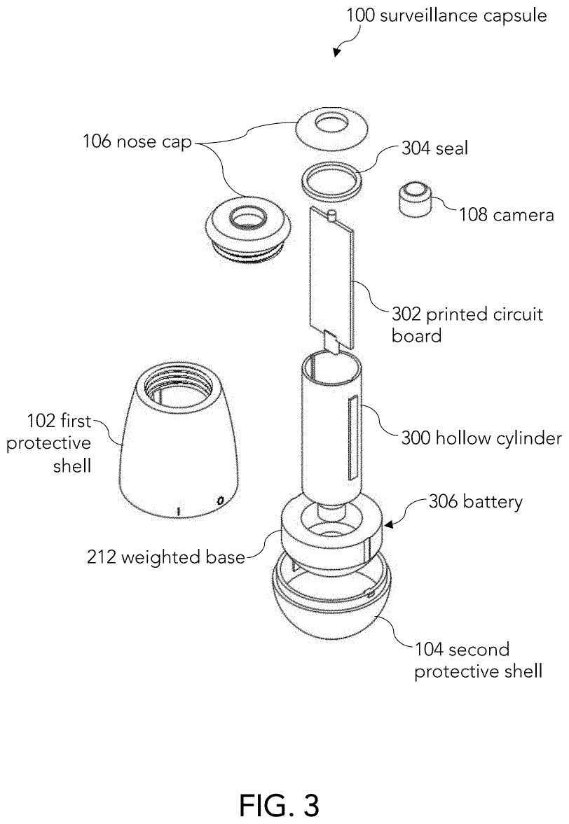

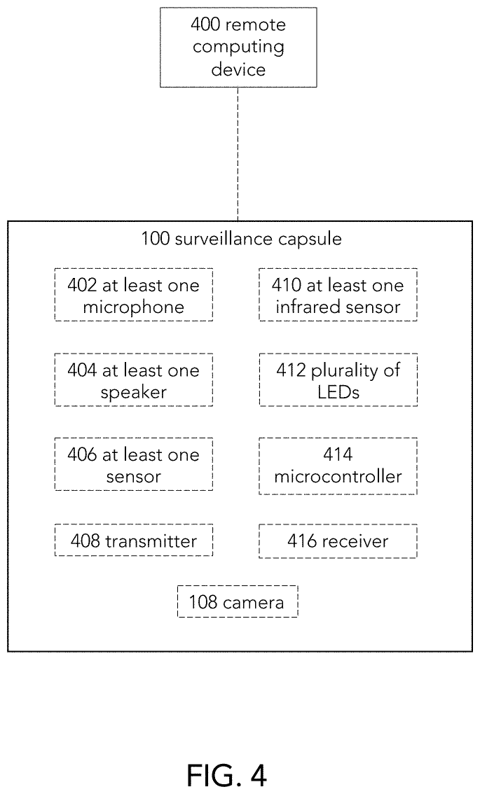

Turning now to FIG. 3, another exploded view of the surveillance capsule 100 is shown. FIG. 3 includes the components shown in FIGS. 1 and 2, as well as a hollow cylinder 300, a printed circuit board (PCB) 302, and a seal 304. In some embodiments, the surveillance capsule 100 includes the hollow cylinder 300 located within the hollow portion 208 of the first protective shell 102 and a PCB 302 located within the hollow cylinder 300. The seal 304 may be configured to couple to the hollow cylinder 300. The PCB 302 may include electrical components configured to enable the operation of the camera 108 as well as several other components of the surveillance capsule 100, which will be discussed further with reference to FIG. 4. In some embodiments, the hollow cylinder 300 is filled with resin, or a similar material, for shock absorption to protect the PCB 302.

The weighted base 212 may include a battery 306, as illustrated in FIG. 3. In some embodiments, the battery 306 contributes to the weight of the weighted base 212, which enables the previously-discussed self-righting property of the surveillance capsule 100. The battery 306 may comprise a rechargeable battery and may be electrically coupled to the camera 108, the PCB 302, and/or any other component of the surveillance capsule 100. The battery 306 may be rechargeable via a charging port located on the surveillance capsule, such as on the second protective shell 104. The battery 306 may also be compatible with a charging dock or other method of receiving power. In some embodiments, the battery 306 comprises a lithium-ion battery. The battery 306 may comprise a different type of battery, such as a solid-state battery.

In some embodiments, the second protective shell 104 is configured to twist to activate, or “turn on,” the battery 306, and, therefore, the electrical components of the surveillance capsule 100. The surveillance capsule may be deactivated, or “turned off” by twisting the second protective shell 104 back to an “off” position. In some embodiments, the second protective shell 104 locks in place once twisted to activate the surveillance capsule 100, and requires a key or other specialized tool, code, etc. to turn off the surveillance capsule 100. This may prevent the surveillance capsule 100 from being unintentionally turned off, such as, for example, if the surveillance capsule 100 is thrown into a building to look for victims during a fire. This may also prevent the surveillance capsule 100 from being intentionally turned off by a perpetrator of a crime, such as, for example, if law enforcement officials attempt to use the surveillance capsule 100 to monitor a crime in progress (i.e., a hostage situation, bank robbery, shooting, etc.).

FIG. 4 illustrates a block diagram of a surveillance system including the surveillance capsule 100 and a remote computing device 400 communicatively coupled to the surveillance capsule 100. In addition to the camera 108, the surveillance capsule 100 may include several components intended for communication and surveillance. For example, as demonstrated in FIG. 4, the surveillance capsule 100 may include at least one microphone 402 and at least one speaker 404. In some embodiments, the at least one microphone 402 and the at least one speaker 404 are configured to enable two-way communication between a first user located adjacent the surveillance capsule 100 and a second user of the remote computing device 400 communicatively coupled to the surveillance capsule 100.

For example, in the event of a building fire, a firefighter may deploy the surveillance capsule 100 into the building while remaining outside. The camera 108 can be used to scan the surrounding environment (i.e., a room or hallway) while the firefighter reviews the video feed from the camera 108 on the remote computing device 400 to look for people in the room or hallway. In the event people are present, the firefighter can use the remote computing device 400, the at least one microphone 402, and the at least one speaker 404 to communicate with the people and issue instructions. In the event no people are seen or heard, the firefighter can move on and not waste time and risk their own safety, or the safety of a fellow firefighter, by sending personnel into the building to conduct a search.

Additional components of the surveillance capsule may include at least one sensor 406, as indicated in FIG. 4. The at least one sensor 406 may define any number and/or type of sensor configured to provide environmental information including, but not limited to, a temperature sensor, a smoke detector, a motion sensor, a gyroscope sensor, a light sensor, and combinations thereof. Any one or a number of these sensors 406 may assist in emergency situations. For example, in the building fire example, in the event that the smoke is too thick for the camera 108 to capture clear images/video and a person is unable to verbally communicate, the at least one sensor 406 comprising a motion sensor can alert emergency personnel to the presence of a person or multiple people in the room or hallway. The at least one sensor 406 comprising a temperature sensor can alert emergency personnel to potential unexpected dangers, such as ultra-high-heat fire due to the burning of hazardous materials.

The surveillance capsule 100 may also include a transmitter 408. In some embodiments, the transmitter 408 is communicatively coupled to the at least one sensor 406 and is configured to transmit information detected by the at least one sensor 406 to the remote computing device 400. Similarly, the transmitter 408 may be communicatively coupled to the camera 108 and configured to transmit the images/video captured by the camera 108 to the remote computing device 400. The transmitter 408 may also be communicatively coupled to the at least one microphone 402 and the at least one speaker 404 and configured to enable the two-way communication discussed above.

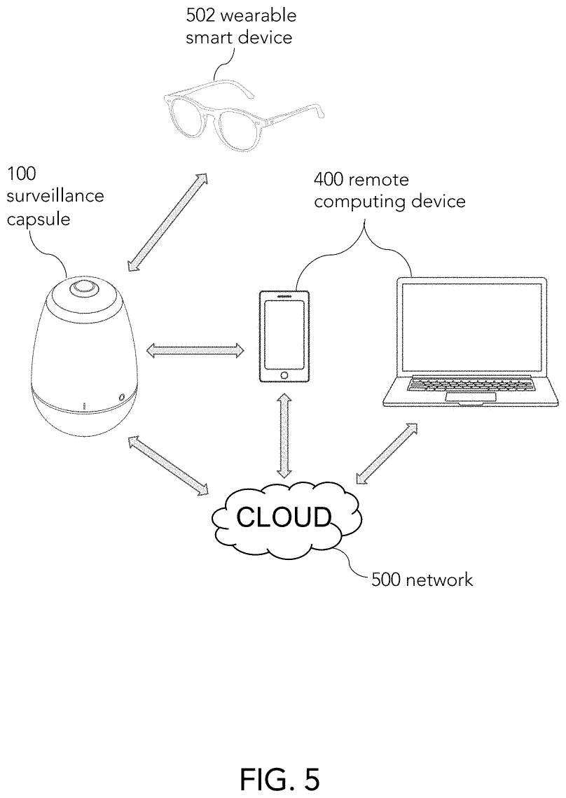

In some embodiments, the transmitter 408 is configured to work in conjunction with the microcontroller 414 and/or the receiver 416 to facilitate the sharing of data (i.e., video, audio, and/or sensor information) between the surveillance capsule 100 and the remote computing device 400. The transmitter 408 and the receiver 416 may both be coupled to the microcontroller 414, and all three elements may be coupled to the PCB 302. A network 500 (illustrated in FIG. 5) may provide a secure network connection between the surveillance capsule 100 and the remote computing device 400. In some embodiments, data is shared between the surveillance capsule 100 and the remote computing device 400 over the network 500. Communications from the transmitter 1408 to the remote computing device 400 may be effected intermediately through a server (not shown) associated with the network 500 or via a direct wireless secure connection established between the transmitter 408 and the remote computing device 400 on an ad hoc basis. The foregoing operations involving the surveillance capsule 100 may be facilitated by the microcontroller (or microprocessor) 414.

The surveillance capsule 100 may also include at least one infrared sensor 410 as indicated by FIG. 4. The at least one infrared sensor 410, in combination with infrared light emitters, may be part of an infrared detection system that may be carried out to detect objects and/or determine environment temperatures (e.g., wall and door temperatures) around the surveillance capsule 100. Artificial intelligence provided locally (not shown) or via a cloud service through the network 500 may use information gathered via the at least one sensor 406 and/or the at least one infrared sensor 410 to determine, for instance, locations of people detected via heat signatures.

To better detect objects, including people, in a dark environment, the camera 108 may be coupled to a night vision system. The at least one infrared sensor 410 may form part of the night vision system. In some embodiments, the night vision system enables full-color vision displayed, for example, on the remote computing device 400. The night vision system may be configured for use in low-light (i.e., half a lumen of ambient light) indoor or outdoor environments, and may enable a user of the remote computing device 400 to see the environment surrounding the surveillance capsule 100 in vivid detail. In some embodiments, the night vision system includes an algorithm that corrects color between the camera 108 and the remote computing device 400 to ensure a clear picture.

As indicated in FIG. 4, the surveillance capsule 100 may include a plurality of LEDs 412. In some embodiments, the plurality of LEDs 412 form part of the night vision system discussed above, for example, to provide sufficient ambient light for the camera 108 to obtain an image/video. The plurality of LEDs 412 may also be configured to emit light from the surveillance capsule 100 for other uses, such as, for example, to capture the attention of a person or people involved in an emergency situation. To use the building fire example previously discussed in this disclosure, one or multiple surveillance capsules 100 may be configured to emit bright light from the plurality of LEDs 412 to indicate an exit or a path (if multiple surveillance capsules 100) to safety. The plurality of LEDs 412 may be configured for several modes of light emission, for example, solid, flashing, blinking, strobing, color-changing, etc. In a situation where multiple surveillance capsules 100 are in use, the plurality of LEDs 412 on each surveillance capsule 100 may emit light simultaneously or sequentially, for example, to indicate a direction of the path to safety.

The plurality of LEDs 412 may comprise a “ring” of LEDs extending around the surveillance capsule 100. In some embodiments, the plurality of LEDs 412 are located inside the surveillance capsule 100 for protection, but the emitted light is configured to be visible from any point around the surveillance capsule 100. The plurality of LEDs 412 may be mounted on the PCB 302 with a light pipe that directs the light from the PCB 302 to emit a glow visible around the surveillance capsule 100.

Any of the components shown in the box in FIG. 4 representing the surveillance capsule 100 may be coupled to any part of the surveillance capsule 100 including, but not limited to, the first protective shell 102, the second protective shell 104, and the nose cap 106. Any of the components may be physically coupled to the aforementioned parts of the surveillance capsule 100 and electrically coupled, via wired or wireless means, to the PCB 302. The PCB 302 may include at least one chip with a neural processor and artificial intelligence capabilities, wherein the chip may be electrically, communicatively, or otherwise coupled to any of the components discussed above. Any of the components may also be electrically coupled, via wired or wireless means, to the battery 306. The surveillance capsule 100 may include components other than (i.e., in addition to or instead of) any of those listed in FIG. 4.

FIG. 5 illustrates a surveillance system including the surveillance capsule 100, the remote computing device 400, the network 500, and a wearable smart device 502. As indicated, the remote computing device 400 may comprise a smartphone or a laptop. The remote computing device 400 may also comprise other types of devices not shown in FIG. 5, for example, a tablet. The wearable smart device 502 is represented in FIG. 5 as a pair of smart glasses, though the wearable smart device 502 may comprise other devices such as, but not limited to, a smartwatch, an armband comprising a touchscreen monitor, etc. A monitor, either of an armband or the remote computing device 400, may enable a user to manipulate the field of view of the camera 108, for example, by dragging a finger (for a touchscreen) or cursor around the screen to “spin” the view and see all the way around the surveillance capsule 100. The remote computing device 400, the wearable smart device 502, and the surveillance capsule 100 may include double-end encryption to protect the data shared between devices.

Through the network 500 and various computing elements of the surveillance capsule 100 (e.g., the transmitter 408, the microcontroller 414, and/or the receiver 416), each of the devices shown in FIG. 5 may be configured to communicate with one another, as previously discussed in this disclosure. For example, the network 500 may enable the sharing of information (i.e., video, audio, images, sensor information) between the surveillance capsule 100 and the remote computing device 400 and/or between the wearable smart device 502 and the surveillance capsule 100. In some embodiments, the receiver 416 is configured to receive commands from the remote computing device 400 and/or the wearable smart device 502 and issue those commands to a component of the surveillance capsule 100. For example, a mobile application of the remote computing device 400 may include a control panel with operations such as turning on/off the plurality of LEDs 412, changing the light emission mode of the plurality of LEDs 412, capturing an image/recording a video from the camera 108, adjusting the volume on the at least one microphone 402 and/or at least one speaker 404, etc. The network 500 may comprise a wireless (i.e., WiFi) network.

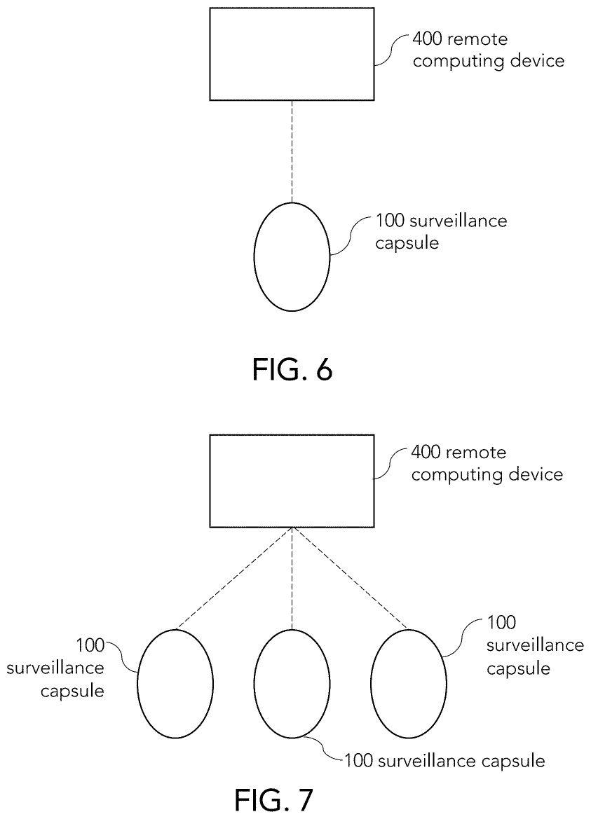

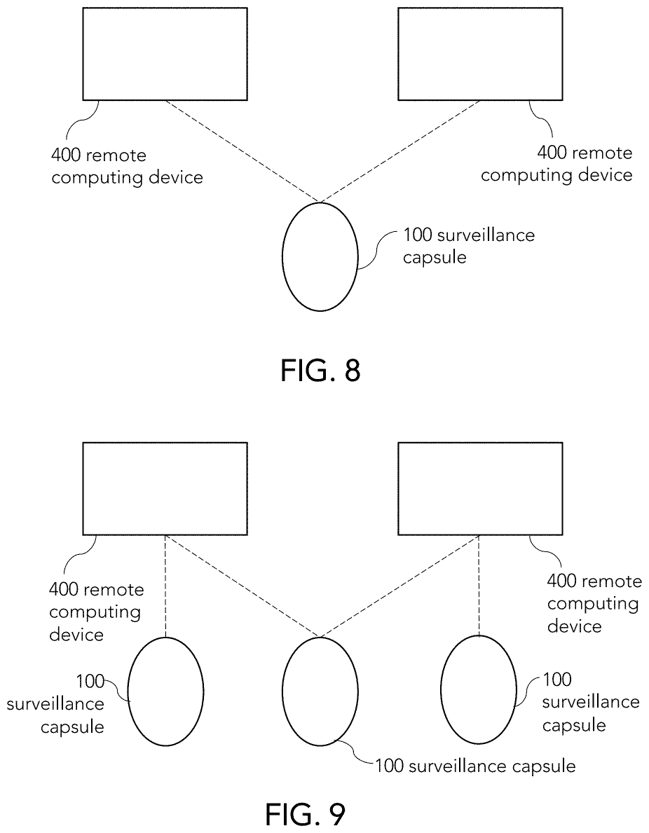

FIGS. 6-9 illustrate different schematic embodiments of a surveillance system including at least one remote computing device 400 and at least one surveillance capsule 100. As mentioned throughout this disclosure, the system may include multiple surveillance capsules 100, as shown in FIG. 7, multiple remote computing devices 400, as shown in FIG. 8, or multiple of both, as shown in FIG. 9. FIG. 6 shows a simpler example comprising a single remote computing device 400 and a single surveillance capsule 100. It should be noted that any number of remote computing devices 400 and surveillance capsules 100 may be configured to work together, and the FIGS. depicting two remote computing devices 400 and three surveillance capsules 100 are intended as non-limiting examples. It should also be noted that the label “remote computing device 400” in FIGS. 6-9 may be construed to include a wearable smart device 502 such as that shown in, and discussed with reference to, FIG. 5.

As mentioned above with regard to the discussion of the plurality of LEDs 412, multiple surveillance capsules 100 may be used together in an emergency situation to, for example, illuminate an exit path. In this manner, multiple surveillance capsules 100 may be “daisy-chained” (literally or figuratively) together to convey a message via peer-to-peer communication. In some embodiments, surveillance capsules 100 may be configured to communicate directly with one another, in addition to, or instead of, communicating with one or multiple remote computing devices 400. Multiple surveillance capsules 100 may also be used simultaneously though used for different purposes. For example, referring back to the hypothetical building fire, multiple surveillance capsules 100 may be deployed to different areas of the building to look for and communicate with victims, while other surveillance capsules 100 are used to identify escape routes. Still other surveillance capsules 100 may be used as range extenders to ensure communication capabilities are maintained. In this way, one can easily conceive that dozens of surveillance capsules 100 may be used at once in a single emergency situation.

As indicated by FIG. 9, multiple remote computing devices 400 may also be used to keep different lines of communication (i.e., with different people on different floors communicating through different surveillance capsules 100) going and/or to issue commands to the surveillance capsules 100 illuminating the escape routes. In some embodiments, as shown in FIG. 7, a single remote computing device 400 may be configured to serve as a “command center” of sorts, and communicate with several surveillance capsules 100. In some embodiments, as shown in FIG. 8, multiple remote computing devices 400 may communicate with a single surveillance capsule 100. For example, one remote computing device 400 may be used for two-way audio communication between an emergency responder and a person in distress, while the second remote computing device 400 is used to issue commands (e.g., lighting, volume, etc.) commands to the same surveillance capsule 100 without interrupting the communication session between the first remote computing device 400 and the surveillance capsule 100.

Further, the network 500 may be linked in a daisy chain fashion to a remote computing device 400 or other hub connection to the network 500. Such connections, therefore, may represent peer-to-peer, peer-to-phone, or peer-to-hub ad hoc networks. The surveillance capsules 100 may relay, for instance, temperature information of walls and/or doors in the surrounding environment to the remote computing device 400 or network 500. Sounds detected by each surveillance capsule 100 may also be relayed to the remote computing device 400 or network 500. Additionally, images/sound/sensor information collected from each surveillance capsule 100 may be relayed through daisy-chained networks to an artificial intelligence entity in the network 500. Instructions/information may be delivered through each receiver 416 of each surveillance capsule 100 from the artificial intelligence entity (which may represent one or more processors) in the network 500. Further, strobe lights generated by the plurality of LEDs 412 may be used to detect objects and or persons in the surrounding environment that may represent victims, perpetrators of crimes, or entities in need of rescue according to the scenario of use at hand. These scenarios include, for instance, a fire scene, a crime scene, or a rescue scene.

In some embodiments, the surveillance system illustrated in FIGS. 1-9 includes a kit comprising additional accessories. These accessories may include a carrying case for the surveillance capsule(s) 100, a launcher for deploying the surveillance capsule(s) into tall buildings and/or across long distances, and any other needed accessories, for example, a key to deactivate (“turn off”) the surveillance capsule(s) 100.

Further, various technologies may be used to provide communication between the various processors and/or memories that may be present within the preceding devices/systems. Various technologies may also allow the processors and/or the memories of the preceding to communicate with any other entity, i.e., to obtain further instructions to access and use remote memory stores, for example. Such technologies used to provide such communication might include a network, the Internet, Intranet, Extranet, LAN, an Ethernet, wireless communication via cell tower or satellite, or any client-server system that provides communication, for example. Such communications technologies may use any suitable protocol such as TCP/IP, UDP, or OSI.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code in a particular programming language are converted to machine language using a compiler, assembler, or interpreter. The machine language is binary-coded machine instructions specific to a specific processing machine, i.e., a particular computer type. The computer understands the machine language.

The various embodiments of the preceding may use any suitable programming language. Illustratively, the programming language may include assembly language, Ada, APL, Basic, C, C++, COBOL, dBase, Forth, Fortran, Java, Modula-2, Pascal, Prolog, REXX, Visual Basic, and/or JavaScript, for example. Further, a single type of instruction or single programming language doesn't need to be utilized in conjunction with the operation of the system and method of the foregoing. Rather, any number of different programming languages may be used as is necessary and/or desirable.

Also, the instructions and/or data used or accessed by software in the foregoing practice may utilize any compression or encryption technique or algorithm, as desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software, for example, that enables the computer operating system to perform the operations described above may be contained on any of a wide variety of media or mediums, as desired. Further, the information/data processed by the set of instructions might also be contained on a wide variety of media or mediums. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmissions, as well as any other medium or source of data that the processors of the foregoing may read.

Further, the memory or memories used in the processing machine that implements the foregoing may be in a wide variety of forms to allow the memory to hold instructions, data, or other information, as desired. Thus, the memory might be in the form of a database to store data. For example, the database might use any desired arrangement of files, such as a flat-file arrangement or a relational database arrangement.

In the system and method of the preceding, a variety of “user interfaces” may allow a user to interface with the processing machine or machines used to implement the foregoing. As used herein, a user interface includes any hardware, software, or combination of hardware and software used by the processing machine that allows a user to interact with the processing machine. A user interface may be in the form of a dialogue screen, for example. A user interface may also include any of a mouse, actuator, touch screen, keyboard, keypad, voice reader, voice recognizer, dialogue screen, menu box, list, checkbox, toggle switch, a pushbutton, or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface that may be used by the processing machine that performs a set of instructions such that the processing machine processes data for a user. The processing machine typically uses the user interface for interacting with a user to convey or receive information from the user. However, it should be appreciated that in accordance with some embodiments of the system and method of the preceding, a human user doesn't need to interact with a user interface used by the processing machine of the foregoing. Rather, it is also contemplated that the foregoing user interface might interact, i.e., convey and receive information, with another processing machine rather than a human user. Accordingly, the other processing machine might be characterized as a user. Further, it is contemplated that a user interface utilized in the system and method of the foregoing may interact partially with another processing machine or processing machines while also interacting partially with a human user.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain.

The various features and processes described above may be used independently of one another or combined in various ways. All possible combinations and subcombinations are intended to fall within the scope of this disclosure. In addition, certain methods, events, states, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, parallel, or some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include 2A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “adjacent” is used to mean “next to or adjoining.” For example, the disclosure includes “a first user located adjacent the surveillance capsule . . . ” In this context, “adjacent the surveillance capsule” means that the user is located next to the surveillance capsule. The placement of the surveillance capsule in the same general space, such as in the same room, as the user would fall under the meaning of “adjacent” as used in this disclosure.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in various forms; furthermore, various omissions, substitutions, and changes in the form of the methods and systems described herein may be made without departing from the spirit of the spirit the inventions disclosed herein.

1. A surveillance capsule, comprising:
a first protective shell defining a first open end, a second open end located opposite the first open end, and a hollow portion extending between the first open end and the second open end;
a second protective shell defining a first open end, a second closed end, and an internal portion located between the first open end of the second protective shell and the second closed end, the first open end coupled to the second open end of the first protective shell;
a nose cap defining a first end, a second end located opposite the first end, and an opening adjacent the first end, whereby the second end of the nose cap is coupled to the first open end of the first protective shell; and
a camera coupled to the opening of the nose cap.

2. The surveillance capsule of claim 1, further comprising a weighted base located within the internal portion of the second protective shell, the weighted base configured to cause the surveillance capsule to be disposed in a free-standing, self-righting, upright position.

3. The surveillance capsule of claim 1, further comprising:
at least one microphone coupled to the first protective shell; and
at least one speaker coupled to the first protective shell, wherein the at least one microphone and the at least one speaker are configured to enable two-way communication between a first user located adjacent the surveillance capsule and a second user of a remote computing device communicatively coupled to the surveillance capsule.

4. The surveillance capsule of claim 3, further comprising at least one sensor selected from the group consisting of a temperature sensor, a smoke detector, a motion sensor, a gyroscope sensor, a light sensor, and combinations thereof, wherein the at least one sensor is coupled to the first protective shell.

5. The surveillance capsule of claim 4, further comprising a transmitter coupled to the first protective shell and communicatively coupled to the at least one sensor, the transmitter configured to transmit information detected by the at least one sensor to the remote computing device.

6. The surveillance capsule of claim 5, wherein the transmitter is configured to transmit at least one image captured by the camera to the remote computing device.

7. The surveillance capsule of claim 5, further comprising a rechargeable battery located within the internal portion of the second protective shell, the rechargeable battery electrically coupled to a component selected from the group consisting of the camera, the at least one microphone, the at least one speaker, the at least one sensor, and the transmitter.

8. The surveillance capsule of claim 1, further comprising:
a hollow cylinder located within the hollow portion of first protective shell; and
a printed circuit board (PCB) located within the hollow cylinder.

9. The surveillance capsule of claim 8, wherein the hollow cylinder is filled with resin to protect the PCB.

10. The surveillance capsule of claim 1, wherein the camera is configured to extend from the opening of the nose cap in a direction opposite the second protective shell.

11. The surveillance capsule of claim 10, wherein the camera is configured to capture at least one image in a field of view defining 360 degrees around the camera.

12. The surveillance capsule of claim 11, further comprising at least one infrared sensor coupled to a component selected from the group consisting of the nose cap, the first protective shell, the second protective shell, and combinations thereof, wherein the at least one infrared sensor is configured to enable night vision.

13. The surveillance capsule of claim 11, further comprising a plurality of light-emitting diodes (LEDs) coupled to a component selected from the group consisting of the nose cap, the first protective shell, the second protective shell, and combinations thereof, wherein the plurality of LEDs is configured to enable night vision.

14. The surveillance capsule of claim 1, wherein the first open end of the second protective shell is threadably coupled to the second open end of the first protective shell.

15. The surveillance capsule of claim 1, wherein the second end of the nose cap is threadably coupled to the first open end of the first protective shell.

16. The surveillance capsule of claim 1, wherein the first protective shell, the second protective shell, and the nose cap are comprised of a ballistic-grade plastic material.

17. A method of providing surveillance using a surveillance capsule, the surveillance capsule including a first protective shell defining a first open end and a second open end located opposite the first open end, a second protective shell coupled to the second open end of the first protective shell, a nose cap coupled to the first open end of the first protective shell, a camera coupled to the nose cap, at least one sensor coupled to the first protective shell, and a transmitter coupled to the first protective shell and communicatively coupled to the camera and the at least one sensor, the method comprising:
capturing, by the camera, at least one image;
detecting, by the at least one sensor, information about an environment surrounding the surveillance capsule; and
transmitting, via the transmitter, the at least one image and the information detected by the at least one sensor to a remote computing device communicatively coupled to the surveillance capsule.

18. The method of claim 17 wherein the surveillance capsule is a first surveillance capsule, the method further comprising:
capturing, by a camera of a second surveillance capsule, at least one image;
detecting, by at least one sensor of the second surveillance capsule, information about an environment surrounding the second surveillance capsule; and
transmitting, via a transmitter of the second surveillance capsule, the at least one image and the information detected by the at least one sensor to a remote computing device communicatively coupled to the second surveillance capsule.

19. The method of claim 18, further comprising transmitting, via the transmitter of the first surveillance capsule, the at least one image and the information detected by the at least one sensor of the first surveillance capsule to the second surveillance capsule.

20. The method of claim 19, further comprising transmitting, via the transmitter of the second surveillance capsule, the at least one image and the information detected by the at least one sensor of the second surveillance capsule to the first surveillance capsule.
